(19) United States
(12) Patent Application Publication
(10) Pub. No.: US 2014/0325950 A1
(43) Pub. Date: Nov. 6, 2014

(54) Forage Harvester with Improved Crop Flow

(71) Applicant: CNH Industrial America LLC, New Holland, PA (US)

(72) Inventors: Geert Verhoye, Ruddervoorde (BE); Jean-Pierre C.E. Lagast, Zedelgem (BE)

(73) Assignee: CNH Industrial America LLC, New Holland, PA (US)

(21) Appl. No.: 14/270,455

(22) Filed: May 6, 2014

(30) Foreign Application Priority Data
May 6, 2013 (BE) BE2013/0308

(51) Int. Cl. A01D 57/00; A01D 45/02; A01D 34/00

(52) U.S. Cl. CPC A01D 57/00; A01D 34/001; A01D 45/02; A01D 34/006
USPC 56/71

(57) ABSTRACT

A forage harvester for harvesting crop is described. The harvester comprises a header for harvesting crop and providing the crop to a cutter drum of the harvester for processing the crop, and a wear plate positioned in the vicinity of the cutter drum to guide the cut crop towards a discharge section of the harvester. The harvester further comprises a flow generator for generating a fluid flow along a surface of the wear plate facing the cutter drum or along an inner discharge surface of the discharge section, in order to facilitate a transport of the cut crop towards an outlet of the discharge section.

### CROSS REFERENCE TO RELATED APPLICATIONS

This application is the US National stage, and claims priority under 35 U.S.C. § 119 to BE 2013/0308 filed on May 6, 2012 and entitled, “Forage harvester with improved crop flow” and having Geert Verhoye and Jean-Pierre C. E. Lagast as the inventors. The full disclosure of BE 2013/0308 is hereby fully incorporated herein by reference.

### FIELD OF THE INVENTION

The present invention relates to harvesting equipment, in particular to a forage harvester for harvesting crop such as corn or grass.

It relates more particularly to the transport of crop that has been harvested towards a discharge spout.

### BACKGROUND OF THE INVENTION

A forage harvester is usually equipped with a header for gathering crop of a field and providing the harvested crop to a cutting or chopping unit such as a chopper, a cutter drum or the like for reducing the size/length of the harvested crop to a desired size. Subsequently, the chopped or processed crop is transported/guided to a discharge section for discharging the cut crop to a container or trailer.

Typically, the flow of processed crop needs to pass through various sections of the discharge section before reaching an outlet. During the transport through the discharge section, the flow of chopped crop may need to undergo various changes in both the direction of flow and cross-section.

It has been observed that, at various positions along the flow path of the cut/chopped crop, there is a risk of so-called plug formation which may result in a (partial) blockage of the passage or section through which the cut crop has to be transported.

### SUMMARY OF THE INVENTION

In order to at least partly mitigate the risk of a plug formation as mentioned, there is provided in an aspect of the present invention, a forage harvester for harvesting crop comprising:
a header for harvesting crop and providing the crop to a cutter drum of the harvester for cutting the crop;
a wear plate positioned in the vicinity of the cutter drum for guiding the cut crop towards a discharge section of the harvester,
wherein the harvester further comprises a flow generator for generating a fluid flow along a surface of the wear plate facing the cutter drum or along an inner discharge surface of the discharge section, in order to facilitate a transport of the cut crop towards an outlet of the discharge section.

In accordance with an aspect of the present invention, there is provided a forage harvester for harvesting crop such as corn or grass. The harvester is provided with a header for harvesting the crop and providing the crop to a cutter drum. Typically, such a header can comprise a cutting member comprising one or more pairs of counter-rotating blades to remove, i.e. harvest the crop from the field. The harvested crop is then fed to a cutter drum (also referred to as cutter head) for reducing the size of the harvested crop. The cut crop (i.e. cut by the cutter drum) may then be transported to a discharge section of the harvester, in order to discharge the cut crop, e.g. towards a spout. In the harvester according to the present invention, there is a wearplate provided in the vicinity of the cutter drum for guiding the cut crop towards the discharge section. Typically, such a wearplate is located at least partly underneath the cutter drum. The wearplate further provides in a shielding of the cutter drum in order to ensure that the cutter drum is not damaged by obstacles that are present on the field. A such, the wearplate is typically a solid plate having a thickness of several mm, up to 1-2 cm. Due to the rotation of the cutter drum, the cut crop (i.e. diminished by the cutter drum) is ejected in substantially radial direction away from the cutter drum towards the wearplate and guided by the wearplate towards the discharge section. Such a discharge section is intended to transport the cut crop towards an outlet, e.g.

provided with a spout, in order to discharge the cut crop into a container or the like. During the transport in the discharge section, the flow of cut crop may typically undergo various changes in both direction of flow and in cross-section. As a result, an important contacting may occur between the cut crop and the walls of the discharge section, i.e. the inner surfaces of the discharge section. It should be noted that a similar contacting occurs with the wearplate when the cut crop is ejected towards the wearplate.

It has been observed by the inventors that, as a result of this contacting, parts of the cut crop may stick or tend to stick to the inner surfaces of the discharge section or the surface of the wearplate facing the cutter drum. Such sticking of the cut crop to the wearplate or the discharge section may result in so-called plug formation, which may eventually result in a (partial) blockage of the passage towards the outlet of the discharge section. In particular when crop with a comparatively high sugar content, such as grass, is harvested, such plug formation may occur. As will be clear to the skilled person, the effect of such plug formation may adversely affect the effectiveness of the harvesting process and may even result in a down-time of the harvester, in case the harvester has to be stopped to remove the plug or plugs formed.

In order to mitigate the risk of such plug formation or sticking of the crop, the forage harvester according to the present invention is provided with a flow generator for generating a fluid flow along a surface of the wear plate facing the cutter drum or along an inner discharge surface of the discharge section. By doing so, a transport of the cut crop towards an outlet of the discharge section is facilitated. The fluid flow, e.g. a fluid comprising an air flow or a mixture of an air flow and a liquid, which is provided along the surface of either the wearplate or the discharge section or both, can provide in a barrier between the cut crop and the surface, thus reducing the likelihood of the cut crop sticking to the surface and generating a plug formation.

In an embodiment, the fluid comprises compressed air which can be dry or humidified. The fluid may further include other components such as inocculants or preservation additives.

In an embodiment, the flow generator comprises a nozzle arrangement for supplying the fluid flow along the surface, the nozzle arrangement preferable extending substantially along the entire width of the cutter drum or the entire width of the discharge section.

In an embodiment, the forage harvester according to the invention can comprise a plurality of flow generators, arranged on either the wearplate or the discharge section or both. Typically, the cross-section of the discharge-section undergoes an important change in size, e.g. starting from a comparatively large cross-section at the inlet, i.e. where the cut crop enters the discharge section to a comparatively small cross-section at the outlet where the discharge section is e.g. connected or connectable to a spout for discharging the cut crop in a container. In an embodiment, a nozzle arrangement of the flow generator is mounted to the discharge section in a position whereby the cross-section of the discharge section undergoes a reduction in size downstream of the position.

Within the meaning of the present invention, downstream is used to denote a direction from the header (harvesting the crop) towards the outlet of the discharge section.

In an embodiment, the fluid flow is controlled by controlling a controllable valve in a conduit supplying the fluid flow. Such a conduit can e.g. be provided between an on-board tank comprising a component of the fluid (e.g. water) and a nozzle arrangement mounted to the wearplate or the discharge section. In such embodiment, a control unit may be provided to control the controllable valve.

In an embodiment, the fluid flow may comprise a pulsed fluid flow. By applying a pulsed fluid flow, the removal of crop sticking to a surface of the discharge section or to the wearplate can be facilitated as it enables to exert important forces onto the crop. Further, compared to a more continuous application of a fluid flow, a smaller amount of fluid may be needed per unit of time.

In an embodiment, the forage harvester according to the invention may be provided with a sensor for generating a signal indicative of a plug formation. As an example, the sensor can comprise a pressure sensor for sensing a pressure or pressure difference along the wearplate or the discharge section. Alternatively, or in addition, a temperature sensor or other type of sensor can be applied.

In an embodiment, the harvester may be provided with further processing tools such as a pair of counter-rotating rolls or drums for breaking the kernels of the crop. Such a processing tool can e.g. be provided downstream of the cutter drum.

According to a further aspect of the invention, there is provided a method of operating a forage harvester, the method comprising:
harvesting a crop by a header of the forage harvester;
providing the harvested crop to a cutter drum of the harvester for cutting the crop;
guiding the cut crop towards a discharge section of the harvester using a wearplate in the vicinity of the cutter drum; and
generating a fluid flow along a surface of the wear plate facing the cutter drum or along an inner discharge surface of the discharge section, in order to facilitate a transport of the cut crop towards an outlet of the discharge section.

### BRIEF DESCRIPTION OF THE DRAWINGS

FIG. 1 schematically depicts a cross-sectional view of a forage harvester according to an embodiment of the invention.

FIG. 2 schematically depicts a cross-sectional view of a cutter drum and wearplate as can be applied in a forage harvester according to a first embodiment of the present invention.

FIG. 3 schematically depicts a top-view of a wearplate and a flow generator as can be applied in a forage harvester according to the invention.

FIG. 4 schematically depicts a cross-sectional view of a cutter drum and wearplate as can be applied in a forage harvester according to a second embodiment of the present invention.

FIG. 5 schematically depicts a more detailed cross-sectional view of a discharge section of a forage harvester according to an embodiment of the invention.

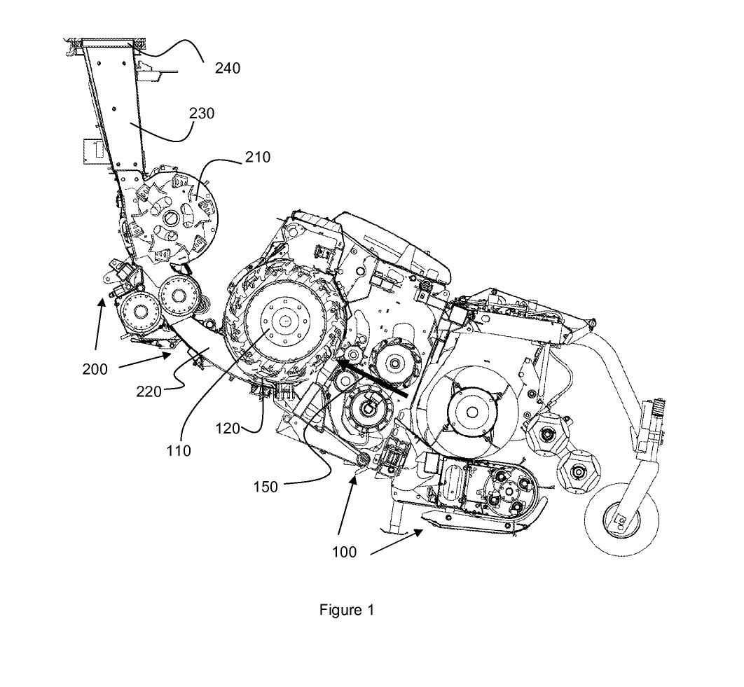

In FIG. 1, an embodiment of a forage harvester according to an embodiment of the present invention is schematically shown. The forage harvester comprises a header 100 for harvesting a crop such as grass or corn. The harvested crop is subsequently transported by the header towards a cutter drum 110, as indicated by the arrow 150. The harvested crop is cut (reduced in size) by the cutter drum and ejected towards a wearplate 120, which is, in the arrangement as shown, arranged substantially below the cutter drum 110. By means of the wearplate 120, the cut crop (i.e. cut by the cutter drum 110) is directed/guided towards the discharge section 200 of the harvester. In the embodiment as shown, the discharge section comprises a first discharge section 220 (also referred to as the concave), a blower 210 downstream of the concave, and a second discharge section 230 having an outlet 240 which can e.g. be connected to a spout (not shown).

In accordance with the present invention, either the wearplate or the discharge section (or both) is provided with a flow generator for generating a fluid flow along either a surface of the wearplate 120 facing the cutter drum 110 or along an inner discharge surface of the discharge section, in order to facilitate the propagation of the cut crop towards the outlet 240 of the discharge section.

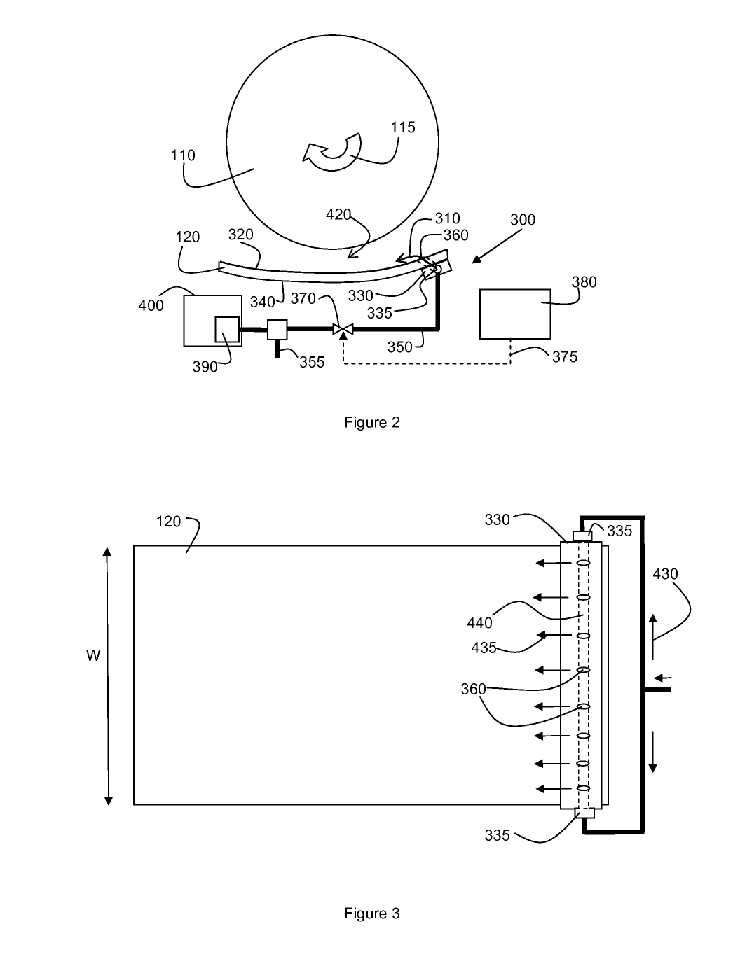

In FIG. 2, a more detailed view of the cutter drum 110, a rotational direction of the cutter drum being indicated by the arrow 115 and wearplate 120 is shown, including a flow generator 300 for generating a fluid flow (indicated by the arrow 310) along a top surface 320 (also referred to as the inner wearplate surface) of the wearplate 120 facing the cutter drum 110. In the embodiment as shown, the flow generator 300 comprises a nozzle arrangement 330 that is mounted to a bottom (or outer) surface 340 of the wearplate, the nozzle arrangement comprising an inlet 335 for receiving a fluid via a conduit 350 and one or more nozzles or jets 360 arranged to provide the fluid, via orifices or protrusions of the wearplate, to flow along the surface 320 facing the cutter drum.

Note that, as an alternative, the nozzle arrangement 330 may also be mounted to the inner wearplate surface 320, thereby eliminating the need to provide protrusions through the wear plate.

Due to the application of the fluid flow along the inner wearplate surface 320, crop which has been cut by the cutter drum 110 and which is ejected by the drum towards the wearplate may no longer stick to the wearplate, thus reducing the risk of plug formation in the region 420 between the cutter drum and the wearplate.

In an embodiment, the nozzles 360 of the nozzle arrangement are arranged such that the fluid flow, when leaving the nozzle or nozzles, has a component in the downstream direction (the downstream direction being the direction from the header (harvesting the crop) towards the outlet of the discharge section).

In an embodiment, the flow generator 300 comprises a controllable valve 370 arranged to control the flow of fluid through the conduit 350. In an embodiment, the controllable valve is controlled (indicated by the dotted line 375) by a control unit 380 of the flow generator.

In an embodiment, the fluid flow may comprises an air flow, e.g. provided by a compressor 390 powered by an engine 400 of the harvester.

The fluid flow may, as an alternative, or in addition, comprise one or more liquid components (e.g. introduced via a further conduit 355) such as water. The fluid flow may further comprise other additives such as inocculants or preservation additives.

In an embodiment, the control unit 380 is arranged to control the valve 370 to generate a pulsed fluid flow. By doing so, the fluid flow may exert a force (directed in the downstream direction) on any crop that may tend to stick or adhere to the wearplate 120 and as such, avoid or mitigate the formation of a plug or plugs.

In FIG. 3, a top view of a wearplate 120 as can be applied in an embodiment of the forage harvester according to the present invention is schematically shown. Compared to the embodiment of FIG. 2, the nozzle arrangement 330 is mounted to the upper surface (the surface facing the cutter drum) of the wearplate 120. The nozzle arrangement 330 comprises a first and second inlet 335 for receiving a fluid flow (indicated by the arrows 430) and providing the fluid flow via an internal conduit 440 to a plurality of nozzles 360 arranged along the width W of the wearplate.

In an embodiment, the nozzles 360 are arranged in such manner that a fluid flow 435 leaving the nozzles 360 is directed substantially parallel to the upper surface of the wearplate. By the application of the fluid flow along the inner surface of the wearplate (as illustrated in both FIGS. 2 and 3), a fluid barrier can be generated between the cut crop ejected from the cutter drum and the surface, thus reducing the likelihood of the cut crop sticking to the surface and generating a plug or plugs.

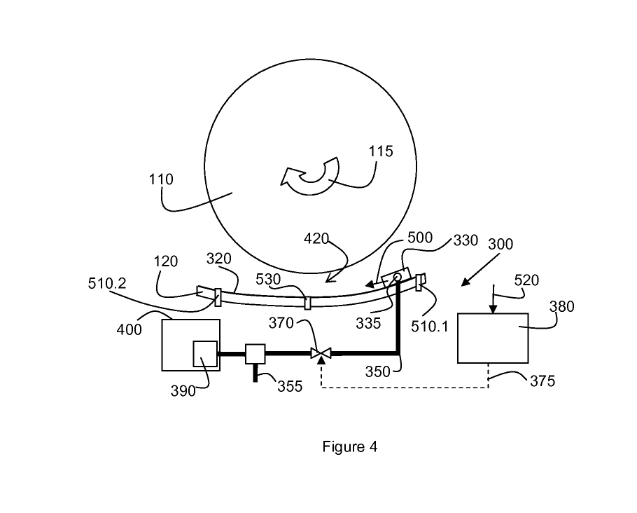

In an embodiment of the present invention, one or more sensors can be provided for generating a signal indicative of a plug formation. Such an embodiment is schematically shown in FIG. 4. As can be seen, the embodiment of FIG. 4 corresponds to the embodiment as shown in FIG. 2, apart from the following:

In the arrangement of FIG. 4, the nozzle arrangement 330 is mounted to the inner wearplate surface 320 (similar to the embodiment of FIG. 3) and is arranged to provide a fluid flow 500 (provided via conduit 350 to an inlet 335 of the nozzle arrangement) essentially parallel to the surface 320. The embodiment as shown further comprises a sensor arrangement 510 for providing a sensor signal 520 indicative of a plug formation. In the embodiment as shown, the sensor arrangement comprises a first pressure sensor 510.1 arranged to detect a pressure at a position upstream of the region 420, i.e. the region where plug formation most likely to occur, and a second pressure sensor 510.2 arranged to detect a pressure at a position downstream of the region 420. In an embodiment, the sensor signal 520, e.g. including signals representing the pressure levels as measured by the sensors 510.1 and 510.2, is provided to the control unit 380 controlling the valve, for controlling an operation of the valve. In the arrangement as shown, the occurrence of a pressure difference between the pressures as sensed by the sensors 510.1 and 510.2 may be an indication of the occurrence of a plug forming in the region 420 between the cutter drum and the wearplate 120. As such, an operation of the valve 370 may be based on the pressure difference.

Note that, as an alternative to the application of a pair of sensors, the application of a single pressure sensor may also provide a signal that may be indicative of a plug formation. Depending on the location of such a single sensor, e.g. upstream or downstream of the region 420, an increase or decrease of the pressure sensed (which can e.g. be derived by the control unit 380) may be an indication of plug formation occurring.

As an alternative, or in addition to the use of one or more pressure sensors, other types of sensors may be applied as well. In the embodiment shown in FIG. 4, a temperature sensor 530 is mounted to the wearplate to measure a temperature of the wearplate, e.g. near the region 420. During normal operation, the cut crop, ejected by the cutter drum, is transported in the downstream direction, while (either continuous or pulsed) the fluid flow 500 provides in a barrier between the cut crop and the wearplate 120, in order to avoid sticking of the crop to the wearplate. Given such conditions, one may expect the temperature as sensed by the sensor 530 to remain substantially constant, or at least proportional to e.g. an ambient temperature or a temperature of the fluid provided. In case a discrepancy in the sensed temperature occurs, this can be considered an indication of the occurrence of plug formation in the region 420. As an example of yet another type of sensor which may be applied, an acoustic sensor can be mentioned. Such a sensor may also provide a signal indicative of the occurrence of a plug formation because the occurrence of a plug of crop (at least partly) blocking the passage of the cut crop through the region 420 may change the acoustic properties of e.g. the wearplate 120. As mentioned, the signal as obtained from the sensor arrangement, (including any type of sensor suitable to generate a signal indicative of a plug formation), can be used by a control unit 380 for controlling the fluid flow, e.g. by controlling a valve in a conduit providing the fluid flow to a nozzle arrangement.

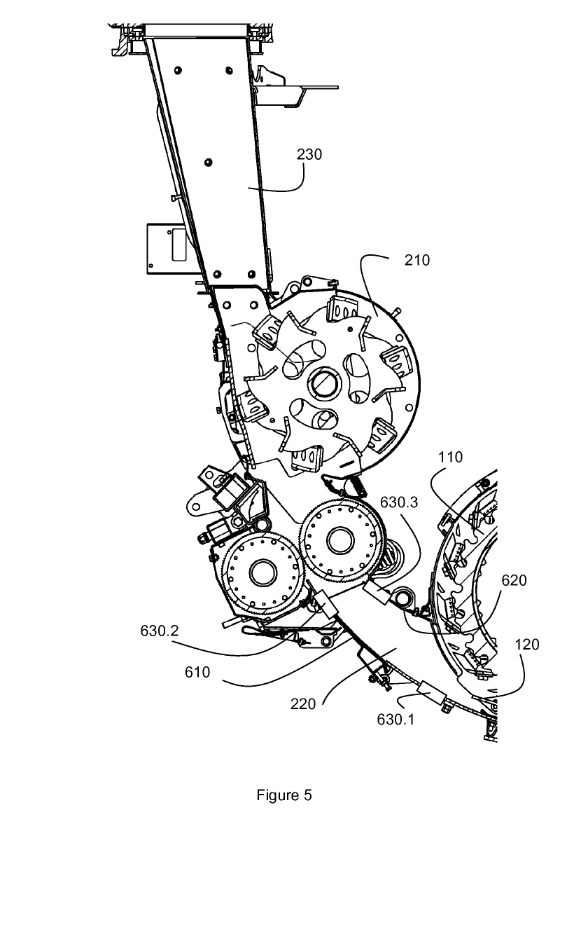

As an alternative, the sensor signal, or a signal derived thereof, may be used to issue a warning signal (e.g. a visual signal or an audio signal) to the operator of the harvester. Once such a signal is issued, the operator may then manually initiate the application of the fluid flow. As mentioned, the risk of plug formation may also occur in the discharge section of the harvester, the discharge section being located downstream of the cutter drum and wearplate. In FIG. 5, a more detailed cross-sectional view on the discharge section of the forage harvester of FIG. 1 is schematically shown. FIG. 5 schematically shows part of the cutter drum 110 and wearplate 120 as e.g. shown in FIG. 1, and the discharge section comprising a first discharge section 220 (also referred to as the concave), a blower 210 and a second discharge section 230, downstream of the blower 210.

The first discharge section is further provided with a three flow generators (630.1, 630.2 and 630.3). The flow generators, which can e.g. include a nozzle arrangement 330 as e.g. shown in FIG. 2 or 4, are mounted to the bottom wall 610 of the concave 220 (flow generators 630.1 and 630.2) and the top wall 620 of the concave 220 (flow generator 630.3).

In an embodiment, a fluid flow as provided by each of the flow generators can be controlled independently, e.g. by controlling a flow through a conduit (not shown) to the different flow generators in a manner as described above. Alternatively, two or more flow generators can be connected to a common conduit and controlled simultaneously.

In a similar manner as illustrated in FIG. 4, one or more sensors (not shown) can be provided on the discharge section in order to provide a signal indicative of the occurrence of a plug formation.

In an embodiment, a flow generator is provided along substantially the entire circumference of the discharge section, i.e. the flow generator may also extend along walls of the discharge section in plane with the drawing. In such arrangement, nozzle arrangements can be provided on either inner surfaces of the walls of the discharge section (e.g. the concave section 220) or outer surfaces of the walls. In the latter case, protrusions are provided through the walls of the discharge section for guiding the fluid flow towards the inner surfaces of the discharge section. In a similar manner as discussed above, one or more flow generators can be provided on the second discharge section 230, downstream of the blower 210.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting, but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language, not excluding other elements or steps). Any reference signs in the claims should not be construed as limiting the scope of the claims or the invention.

The mere fact that certain measures are recited in mutually different dependent claims does not indicate that a combination of these measures cannot be used to advantage.

What is claimed is:

1. A forage harvester for harvesting crop comprising:
a header that harvests crop and provides the crop to a cutter drum for a cut thereof;
a wear plate positioned in substantial vicinity of the cutter drum to guide the cut crop towards a discharge section of the forage harvester,
a flow generator that generates a flow of at least one of fluid and air along one of a surface of the wear plate facing the cutter drum or along an inner discharge surface of the discharge section, in order to facilitate a transport of the cut crop towards an outlet of the discharge section.

2. The forage harvester according to claim 1 wherein the flow generator is provided on an upstream end section of the wear plate.

3. The forage harvester according to claim 1 wherein the flow generator comprises a nozzle arrangement for providing the fluid flow.

4. The forage harvester according to claim 1, wherein the flow generator extends along a width of the cutter drum.

5. The forage harvester according to claim 1, wherein the fluid flow is at least partly directed downstream.

6. The forage harvester according to claim 1, wherein the discharge section comprises a concave, arranged downstream of the wearplate.

7. The forage harvester according to claim 6 wherein the concave is provided with the flow generator that generates the fluid flow along an inner concave surface of the concave.

8. The forage harvester according to claim 1, wherein the fluid flow comprises an air flow or a mixture of air and a liquid such as water.

9. The forage harvester according to claim 1 the flow generator further comprises a compressor.

10. The forage harvester according to claim 1, wherein the flow generator further comprise an on-board tank for storing a liquid for generating the fluid flow.

11. The forage harvester according to claim 10, wherein the flow generator further comprise a nozzle arrangement mounted to one of the wearplate or the discharge section, a conduit connecting the on-board tank to the nozzle arrangement and a controllable valve that controls the fluid flow to the nozzle arrangement.

12. The forage harvester according to claim 11, further comprising a control unit for controlling an operation of the controllable valve, a sensor for generating a signal indicative of a plug formation and wherein the control unit is arranged to receive the signal and control the operation of the controllable valve based on the signal.

13. The forage harvester according to claim 12, wherein the control unit is arranged to control the operation of the controllable valve to provide in a pulsed fluid flow.

14. The forage harvester according to claim 12, wherein the sensor comprises a pressure sensor or a temperature sensor.

15. A method of operating a forage harvester, the method comprising:
harvesting a crop by a header of the forage harvester;
providing the harvested crop to a cutter drum of the harvester for cutting the crop;
guiding the cut crop towards a discharge section of the harvester using a wearplate in substantial vicinity of the cutter drum; and
generating a fluid flow along a surface of the wear plate facing the cutter drum or along an inner discharge surface of the discharge section, in order to facilitate a transport of the cut crop towards an outlet of the discharge section.
